(19) United States
(12) Patent Application Publication
(10) Pub. No.: US 2024/0286528 A1
(43) Pub. Date: Aug. 29, 2024

(54) SUSPENSION ASSEMBLY

(71) Applicant: GRIPPLE LIMITED, Sheffield, South Yorkshire (GB)

(72) Inventor: Samuel Barnes, Sheffield, South Yorkshire (GB)

(21) Appl. No.: 18/571,994

(22) PCT Filed: Jul. 14, 2022
(86) PCT No.: PCT/IB2022/056487

§ 371 Date: Dec. 19, 2023

(30) Foreign Application Priority Data
Jul. 19, 2021 (GB) 2110316.3
Mar. 28, 2022 (GB) 2204338.4
Jul. 11, 2022 (GB) 2210130.7

(51) Int. Cl. B60M 1/23; B60M 1/24

(52) U.S. Cl. CPC B60M 1/23; B60M 1/24

(57) ABSTRACT

The present disclosure relates to a securing arrangement (102), a suspension assembly (100), and a method. The securing arrangement (102) is for suspending an elongate member (10). The securing arrangement (102) comprises a first securing device (1, 34) for securing an elongate support (6). The securing arrangement (102) further includes a second securing device (30, 44, 70) for securing the elongate member (10). Each of the first and second securing devices (1, 34 and 30, 44, 70) comprises a main part (2, 36, 111), a securing member (15, 117A, 117B, 38, 60) movably mounted on the main part (2, 36, 111), and an urging member (21, 42, 64, 122A, 122B) for urging the securing member (15, 117A, 117B, 38, 60) from a release position to a securing position in which the elongate support (6) or the elongate member (10) are secured by the securing member (15, 117A, 117B, 38, 60).

This invention relates to suspension assemblies. More particularly, but not exclusively, this invention relates to suspension assemblies for suspending contact cables from messenger wires in overhead electric railway lines. Embodiments of this invention relate to dropper assemblies for use in overhead electric lines for electric railway systems.

Electrified railways overhead lines comprise a catenary wire (known as a “messenger wire” in the art) which is joined to a contact cable by a suspension assembly (known as a “dropper” in the art). The trains use a pantograph to collect electricity from the contact cable. Droppers comprise a conductive wire rope of a predetermined length, and conductive manual clamps is attached to both ends of the wire rope. The length of the wire rope varies between droppers to maintain a substantially straight contact cable beneath the catenary curve of the messenger wire. The predetermined lengths are pre-set off site and the wire ropes attached to the manual clamps. Because the droppers rely on clamps and a set length for installation there can be difficulties mounting them in the right place to gain the correct support, and therefore not create tension or slack in the messenger or contact lines.

According to one aspect of the invention, there is provided a suspension assembly comprising: a securing arrangement and an elongate member suspended from the securing arrangement; wherein the securing arrangement comprises a first securing device for securing an elongate support, and the securing arrangement further includes a second securing device for securing the elongate member; and wherein each of the first and second securing devices comprises a main part, a securing member movably mounted on the main part, and an urging member for urging the securing member from a release position to a securing position in which the elongate support or the elongate member are secured by the securing member.

According to another aspect of the invention, there is provided a securing arrangement for use in a suspension assembly described above, the securing arrangement comprising a first securing device for securing an elongate support, and the securing arrangement further including a second securing device for securing an elongate member.

According to another aspect of this invention, there is provided a method of using a suspension assembly described above, comprising fastening the first securing device to the elongate support, fastening the elongate member to the second securing device, and arranging the elongate support and the elongate member in electrical contact.

The suspension assembly may comprise a dropper assembly.

The first securing device may comprise a gripping device. The gripping device may be arranged to grip the elongate support.

The gripping device may have hooks extending from the main part. The hooks may curve in opposite directions from the main part. A gap may be defined between the hooks. The elongate support may be received in the gap, and the gripping device rotated about the gap so that the elongate support is received by both hooks.

The securing member of the gripping device may comprise a cam lever, which may be pivotally mounted on the main part of the gripping device. The cam lever may press the elongate support against the hooks.

The cam lever may comprise a cam face for engaging the elongate support. The cam lever may further include a release member for releasing the cam face from the elongate support. The release member may comprise an arm of the cam lever.

The urging member may be resilient. The urging member may comprise a spring. The spring may be a compression spring.

The gripping device may comprise two of the securing members and two of the urging members. Each of the securing members may have the features of the securing member described above. Each of the urging members may have the features of the urging member described above.

Alternatively, the securing member of the gripping device may comprise a cam member. The cam member may be pivotally attached to the main part. The cam member may have a substantially planar engaging region for engaging the elongate support to fasten the elongate support to the gripping device. The cam member may clamp the elongate support against the hooks. The cam member may be partially circular.

The urging member may comprise an over-centre lever. The urging member may be connected to the cam member. The cam member may have a pivot point to pivotally attach the cam member to the main part, the pivot point being offset from the centre of the cam member in a direction away from the engaging region.

The cam member may be pivotable between a gripping position and a non-gripping position. The pivoting of the cam member may be effected by moving the over-centre lever through. In the gripping position, the engaging region may engage the elongate support to press the elongate support against the hooks.

The cam member may be pivotable through 180°, but it will be appreciated that the cam member may be pivotable by any other suitable angle which may be greater or less than 180°, such as an angle between 90° and 180°. The over centre lever may be pivotable through 180° to pivot the cam member, but it will be appreciated that the over-centre lever may be pivotable by any other suitable angle which may be greater or less than 180°, such as an angle between 90° and 180°.

The second securing device may comprise a clamping device. The clamping device may comprise a passage through which the elongate member extends.

The clamping device may comprise a housing defining the passage. The clamping device may have a clamping mechanism for the passage. The clamping mechanism may have a securing member, which may comprise a clamping member. The clamping mechanism may include a spring. The spring may urge the clamping member to a clamping position in which the elongate member is clamped. The urging of the clamping member to the clamping position may urge the clamping member towards the passage.

The clamping mechanism may clamp the elongate member against an electrical conductor. This may enable electrical power transfer between the elongate support and the elongate member.

The securing arrangement may comprise one or more holes through which an end region of the elongate member can be looped. The direction of the one or more holes may be nonparallel to the passage. Each hole may be configured to receive a respective pass of the elongate member.

The clamping device may have a housing defining two passages. The two passages may be parallel. The clamping device may have a respective clamping mechanism for each passage. Each clamping mechanism may have a securing member, which may comprise a clamping member. Each clamping mechanism may include a respective spring. Each clamping mechanism may include a respective spring in each passage. Each spring may urge the respective clamping member to a clamping position in which the elongate member is clamped. The urging of the clamping members to the clamping positions may urge the clamping members towards the respective passage.

Each passage may be configured to receive a respective pass of the elongate member. When so received, the clamping mechanisms may be operable on the passes of the elongate member, thereby securing the elongate member to the clamping device.

An end region of the elongate member may extend through the hooks in contact with the elongate support to be clamped against one another and the hooks by the cam levers or the cam member. Thus, the elongate member effects electrical contact with the elongate support.

The suspension arrangement may comprise a connecting portion to connect the clamping device to the gripping device. Alternatively, the clamping device and the gripping device may be in a layered arrangement. The elongate member may be clamped in one of the passages of the clamping device. The elongate member may extend from said passage across the elongate support to the gap. Thus, the elongate member may extend from the clamping device to engage the elongate support in the gap. The elongate member may extend from the gap to the clamping device to be received in the other of the passages and clamped therein or to be received in the one or more holes.

The clamping device may comprise a housing defining a single passage through which the elongate member extends. The clamping device may have a clamping mechanism to clamp the elongate member in the passage. The clamping mechanism may have a securing member in the form of a clamping member. The clamping member may be mounted on a carriage.

The clamping mechanism may further include a spring to urge clamping member to a clamping position. The spring may urge the clamping member to the clamping position by urging the carriage.

The clamping mechanism may have two oppositely arranged securing members in the form of clamping members. The clamping members may be mounted on a carriage.

The clamping mechanism may further include a spring to urge the clamping members to a clamping position. The spring may urge the clamping members to the clamping position by urging the carriage.

The suspension arrangement may comprise a connecting portion to connect the gripping device to the clamping device. The elongate member may be inserted through the clamping device. An end region of the elongate member may be arranged to extend from the clamping device to the gripping device. Alternatively, the clamping device and the gripping device may be in a layered arrangement. The end region of the elongate member may be received through the hooks of the gripping device

The end region of the elongate member and the elongate support may be clamped against one another and the hooks by the cam levers or the cam member.

The clamping device may have a locking arrangement to lock the clamping member in the clamping position.

The locking arrangement may comprise a screw which can be screwed into the housing to engage the clamping members and lock the clamping members in their clamping positions. Where the clamping device has two clamping mechanisms, each clamping mechanism may comprise a respective one of the locking arrangements.

The locking arrangement may comprise a threaded member on the carriage. The threaded member may project from the main part. The locking arrangement may include a locking member, which can be screwed onto the threaded member to lock the clamping members in clamping engagement with the elongate member.

Alternatively, the locking arrangement may comprise a button which is actuatable by hand to release the clamping member. The button may be a push button. When the button is released, the spring may return the clamping member to the clamping position.

Alternatively, the locking arrangement may comprise a cam locking member. The cam locking member may be rotatable between a non-locking position and a locking position.

The cam locking member may be held between the passages. The cam locking member may be held within the holding within the clamping wall.

In the non-locking position, the substantially flat faces may be aligned with the respective surfaces of the clamping wall. In the locking position, the cam surfaces may protrude into the passages.

The cam locking member may comprise a main cam portion and an operating portion on the main cam portion. The main cam portion may be held within an aperture defined by the clamping wall. The operating portion may be arranged, or may face, outside the housing. Thus, the operating portion may be rotated by a user.

The main cam portion may comprise two opposite substantially flat faces two opposite cam surfaces. The flat faces and the cam surfaces may be arranged alternately on the main cam portion. The cam surfaces may be convexly curved surfaces.

In use, the two passes may be initially clamped by the clamping members, with the cam locking member in the non-locking position. The cam locking member may be rotated to the locking position. In the locking position, the cam surfaces may push the passes against the respective clamping member to lock the passes against the clamping member.

The elongate member may have a main portion which extends downwardly to a further securing arrangement for securing the elongate member to an elongate contact article. The further securing arrangement may comprise a further first and second securing devices. The first securing device may comprise a further gripping device. The second securing device may comprise a further clamping device. The further gripping device may be the same as the gripping device described above. The further clamping device may be the same as the clamping device described above.

Embodiments of the invention will now be described by way of example only, with reference to the accompanying drawings, in which:

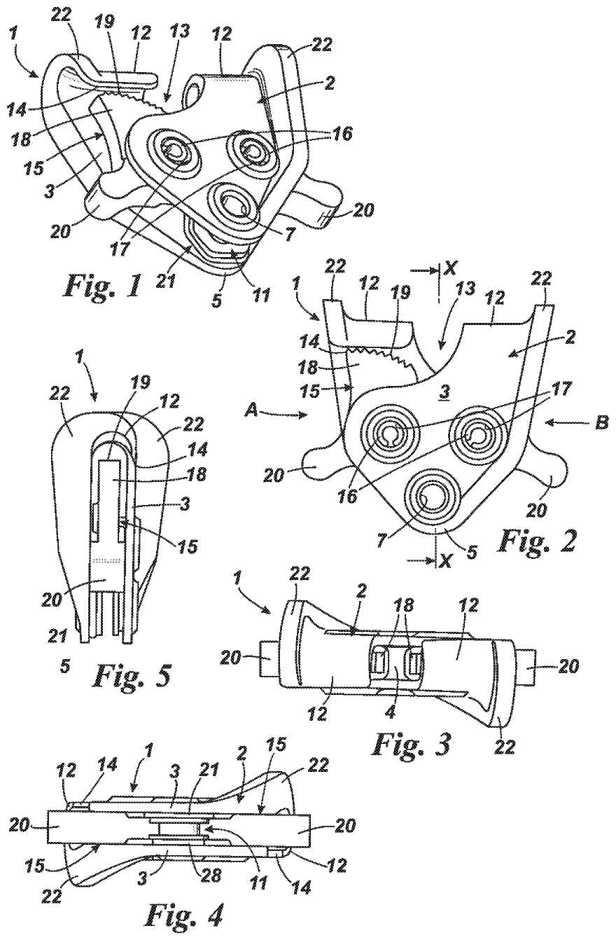

FIG. 1 is an isometric view from one side of a gripping device for use in a suspension assembly;

FIG. 2 is an elevation of the other side of the gripping device;

FIG. 3 is a view of the gripping device from above;

FIG. 4 is a view of the gripping device from below;

FIG. 5 is an elevation of the gripping device as seen in the direction of arrow A or arrow B in FIG. 2;

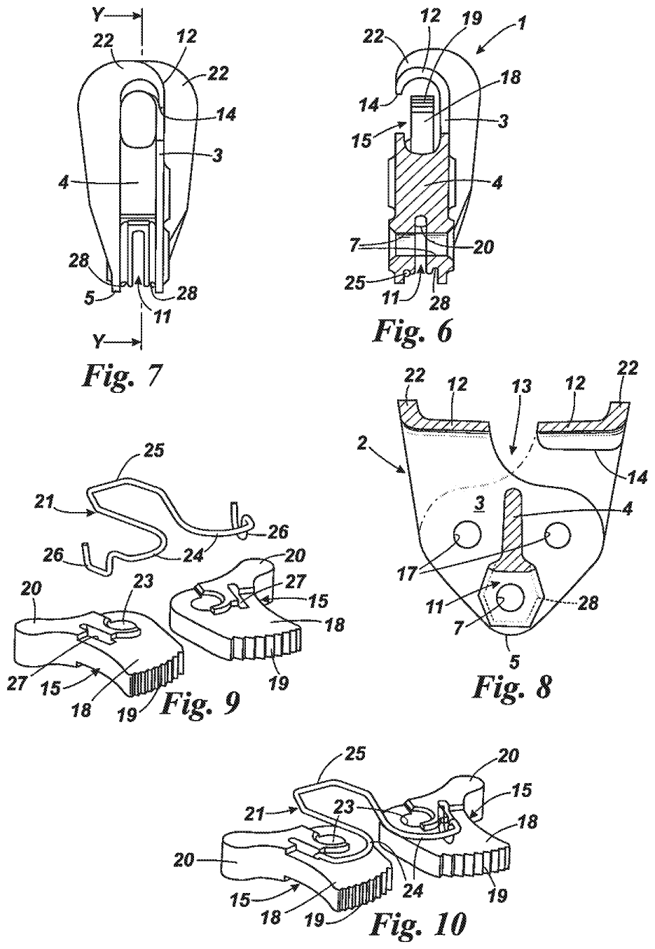

FIG. 6 is a section taken from the line X-X in FIG. 2;

FIG. 7 corresponds to FIG. 5 but with internal components omitted from the main part of the device;

FIG. 8 is a section taken from the line Y-Y in FIG. 7;

FIG. 9 is an isometric view of the internal components before assembly;

FIG. 10 corresponds to FIG. 9 but shows the sub-assembly formed by the internal components;

FIG. 11 is an isometric view showing the sub-assembly inverted and positioned ready for insertion into the main part;

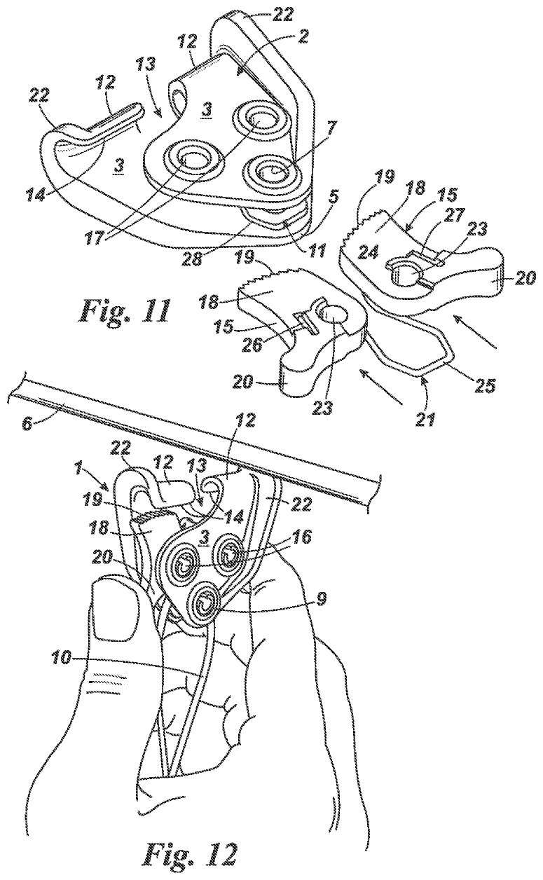

FIGS. 12 to 16 are fragmentary perspective views showing stages in the application of the device to an elongate support (catenary, wire or cable, or rod);

FIG. 17 is a section similar to that of FIG. 8 but through the complete device engaged with an elongate support;

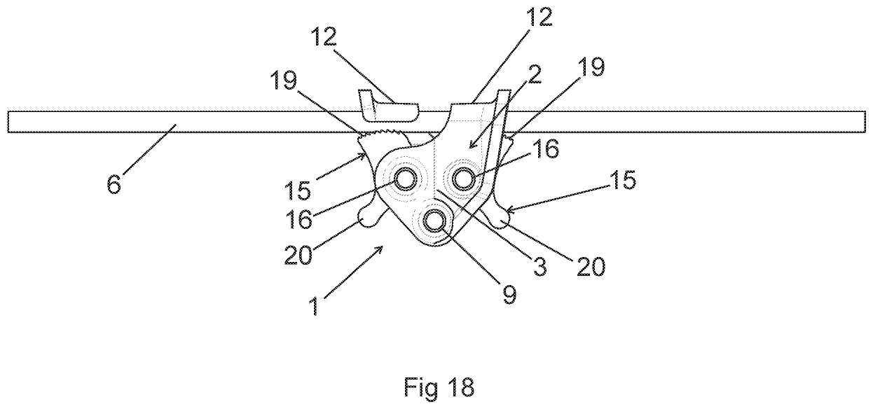

FIG. 18 is a front view showing a gripping device for use in a suspension assembly, in which the gripping device grips an elongate support;

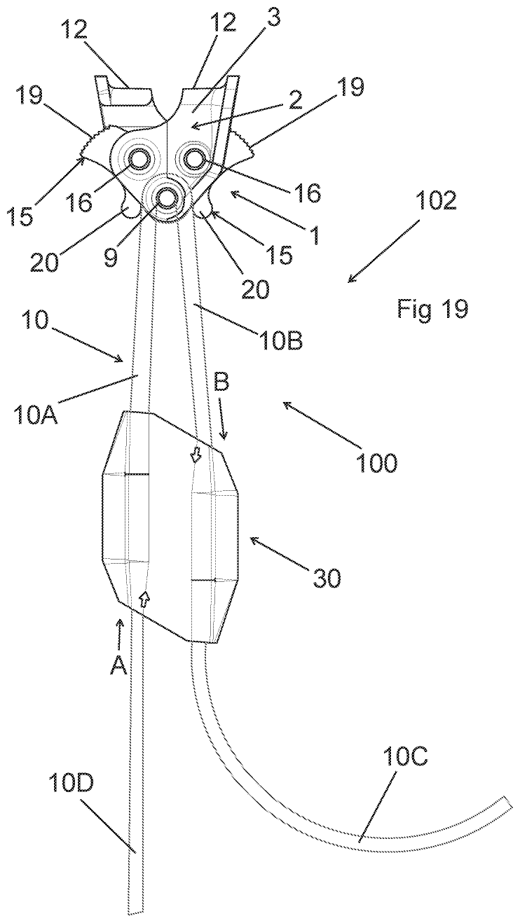

FIG. 19 is a front view of a suspension assembly comprising the gripping device shown in FIG. 18, and a clamping device for clamping an elongate member;

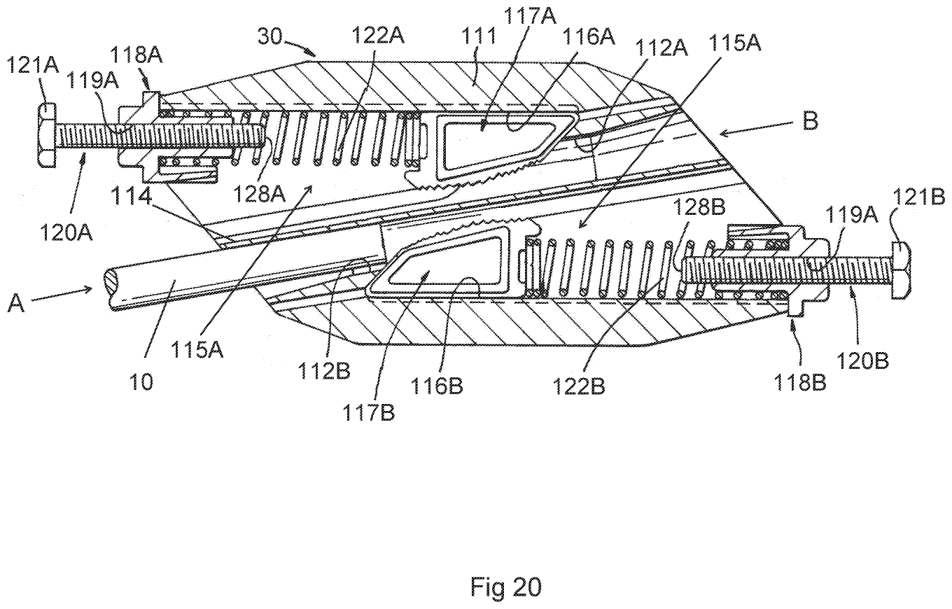

FIG. 20 is a sectional view of a clamping device;

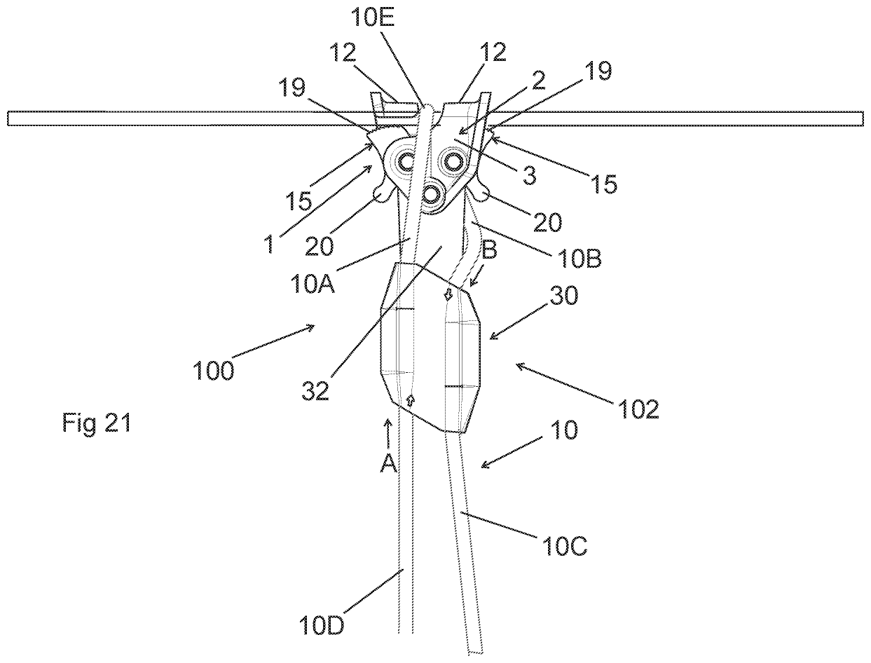

FIG. 21 is a front view of another suspension assembly comprising the gripping device shown in FIG. 18 attached to a clamping device, in which an elongate member is shown engaging the elongate support;

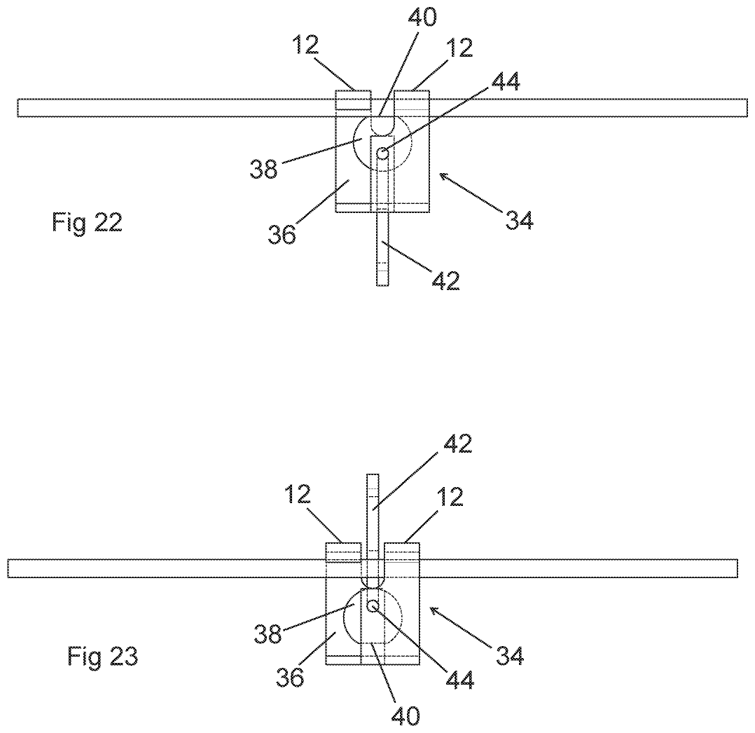

FIG. 22 is a front view of another gripping device in which a gripping member is shown in a gripping position;

FIG. 23 is a front view of the gripping device shown in FIG. 22, in which the gripping member is shown in a release position;

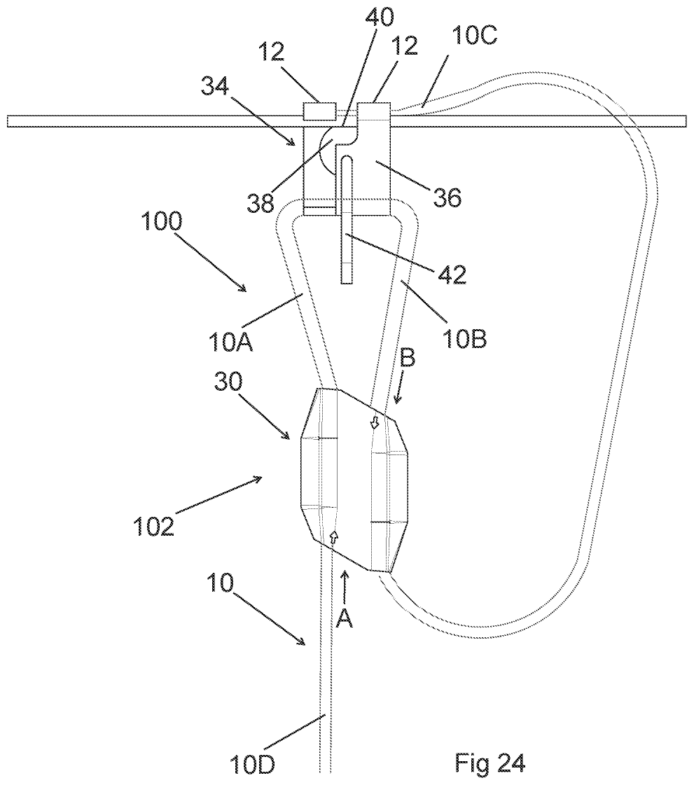

FIG. 24 is a front view of a suspension assembly incorporating the gripping device shown in FIG. 22 and further comprising a clamping device, in which an elongate member shown in contact with the elongate support;

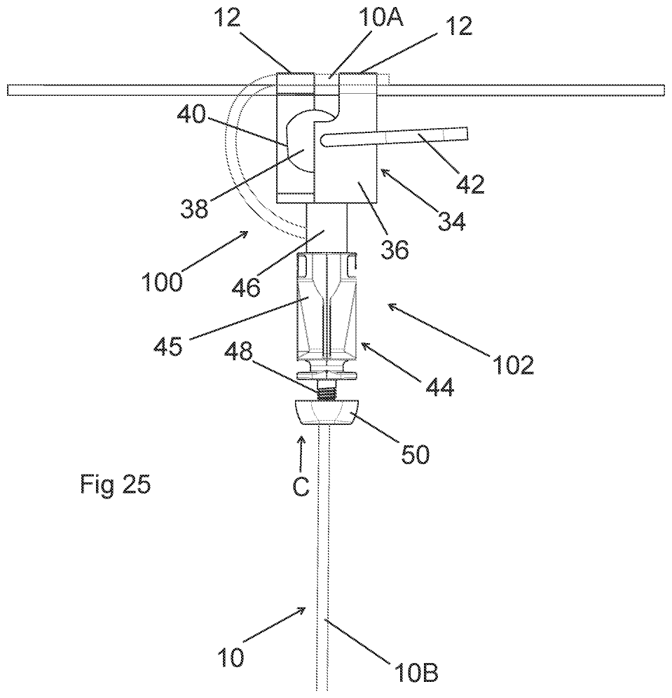

FIG. 25 is a front view of another suspension assembly comprising the gripping device shown in FIG. 22 attached to a clamping device, in which an elongate member is shown in contact with the elongate support;

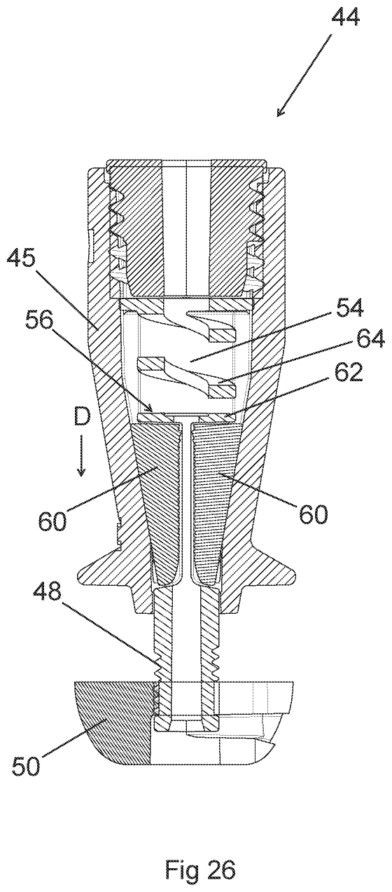

FIG. 26 is a cross-sectional view of a clamping device for use in the suspension assembly shown in FIG. 25;

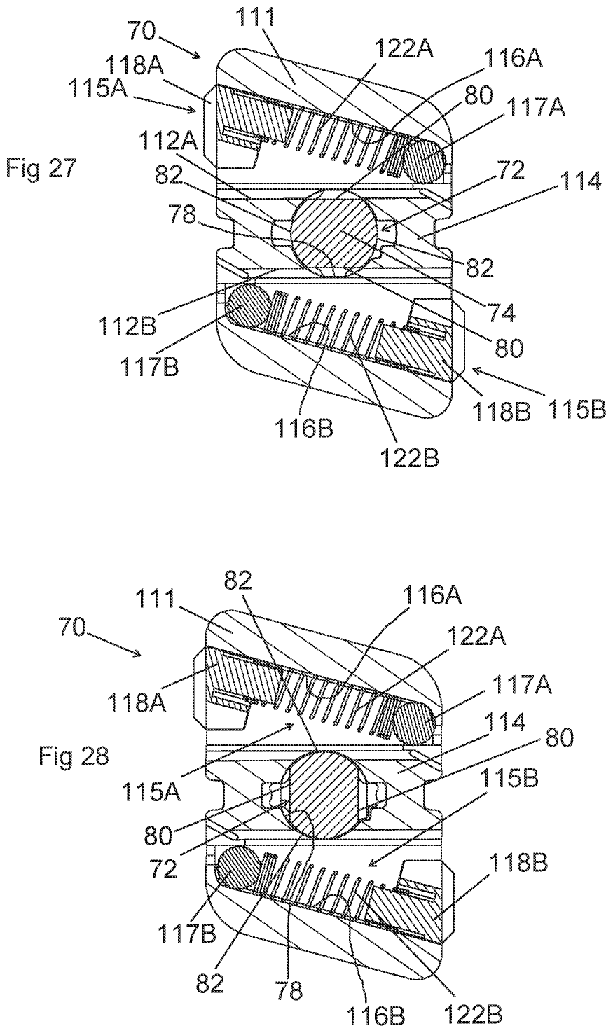

FIG. 27 is a sectional view of a further clamping device showing a cam locking member in a non-locking position;

FIG. 28 is a view similar to FIG. 27, showing the cam locking member in a locking position;

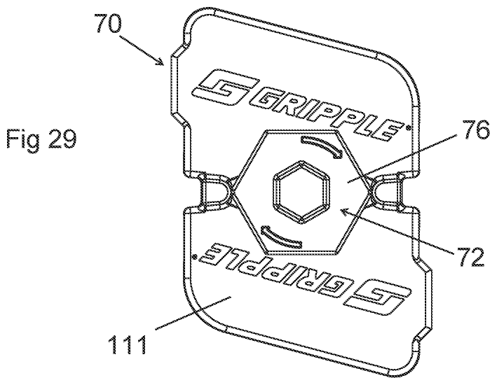

FIG. 29 is a plan view of the further clamping device shown in FIGS. 27 and 28, showing an operating portion of the cam locking member;

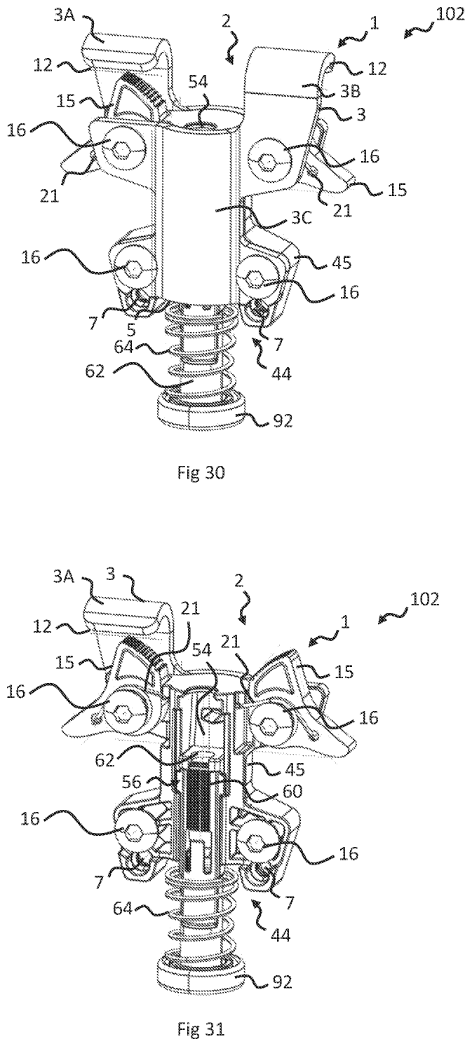

FIG. 30 is a front perspective view of an integrated gripping device and clamping device;

FIG. 31 is a front perspective view of the integrated gripping device and clamping device, with a side member removed;

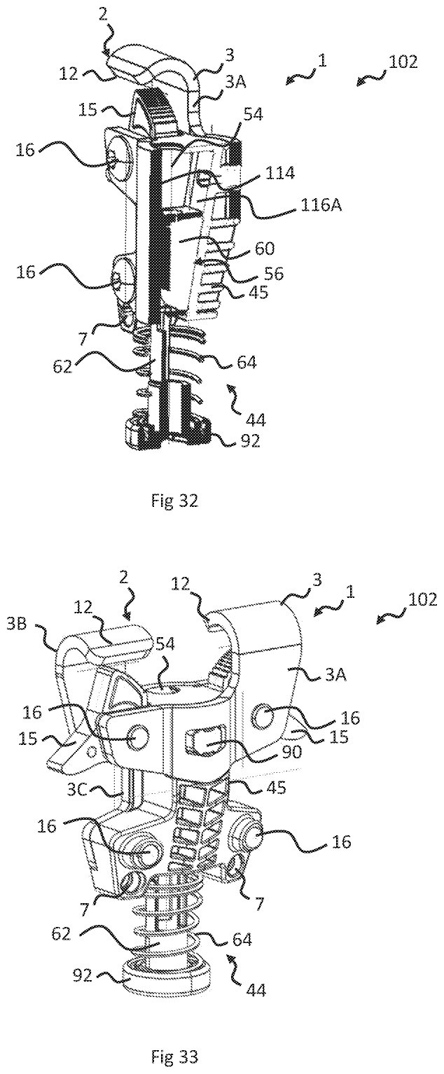

FIG. 32 is a side cross-section view of the integrated gripping device and clamping device; and

FIG. 33 is a rear perspective view of the integrated gripping device and clamping device.

The drawings show a suspension assembly 100, which is in the form of a dropper assembly for use in overhead electric cables for railway lines. The suspension assembly provides a conductive elongate member 10 electrically connected between a conductive elongate support 6 carrying electric current, and a conductive elongate contact article in the form of a contact cable.

The suspension assembly 100 comprises a securing arrangement 102 and the elongate member 10. The securing arrangement 102 clamps the elongate support 6 and the elongate member 10. The securing arrangement 102 comprises a gripping device 1 or 34 and a clamping device 30 or 44.

FIGS. 1 to 11 show the gripping device 1, which has a main part 2 in the form of a body. The main part 2 has two spaced plate-like side members 3 connected together by an integral medial wall 4 adjacent one end 5, thereby forming a housing.

The end 5 is a lower end when the device is in use on the elongate support 6. The elongate support 6 is in the form of a messenger wire, formed by a catenary (wire or cable).

The gripping device 1 further includes means at the lower end 5 consisting of holes 7 in the side members enabling the elongate member 10 to be suspended from a rolled steel pin 9 through the holes. A looped portion of the elongate member 10 can be received in a slot 11 formed between the lower ends of the side members 3 below the medial wall 4. When so received, the looped portion of the elongate member 10 engages the pin 9, thereby suspending the elongate member 10 from the gripping device 1.

Two hooks 12 are formed integral one with each side member 3 curving over in opposite directions towards the respective opposite side member and defining between them an upwardly facing transverse gap 13, the width of the gap 13 and the spacing of the free end 14 of each hook 12 from the respective opposite side member 3 being not less than the diameter of the elongate support 6 to which the device is to be applied.

Two securing members in the form of cam levers 15 are pivoted on respective rolled steel pins 16 between holes 17 in the side members 3, upper arms 18 with ribbed cam faces 19 being directed towards respective hooks 12, lower arms 20 projecting away from each other and out from the main part 2 adjacent the lower end 5, and spring means 21 within the main part 2 urging the lower arms 20 apart and urging the cam faces 19 towards their respective hooks 12.

The hooks 12 are strengthened by ribs or flanges 22 extending round them from the outer faces of the respective side members 3 and at the edges of the side members remote from the gap 13.

Referring particularly to FIGS. 9 to 11, the cam levers 15 have holes 23 for the pivot pins 16 and the lower arms 20 are thicker than the upper arms 18 to afford room between the latter and an adjacent side member 3 of the main part 2 for accommodating the spring means 21. The cam levers 15 are symmetrical about mid-planes so as not to be handed.

The spring means 21 is formed with two torsion loops 24 passing over respective pivot pins 16 from an integral loop 25 to anchoring limbs 26 which are a push-fit in respective slots 27 in the cam levers 15, whereby the cam levers 15 and spring means can be pre-assembled, as illustrated by FIGS. 9 and 10.

In FIG. 11, the sub-assembly of cam levers 15 and spring means is shown after inversion and ready to be pushed, as indicated by the pair of parallel arrows, into place in the main part 2 with the cam levers 15 passing into cavities formed between the side members 3 one to each side of the medial wall 4, the integral loop 25 then snapping into one of a pair of grooves 28 in the lower end of the main part 2 (which is symmetrical about a mid-plane so as not to be handed) and the cam lever 15 secured by inserting the pivot pins 16, to complete the device as shown in FIG. 1.

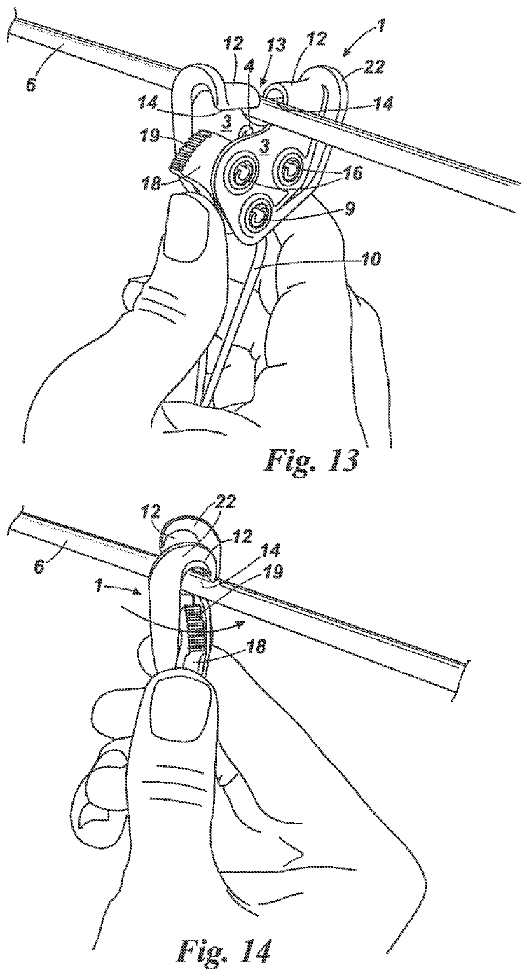

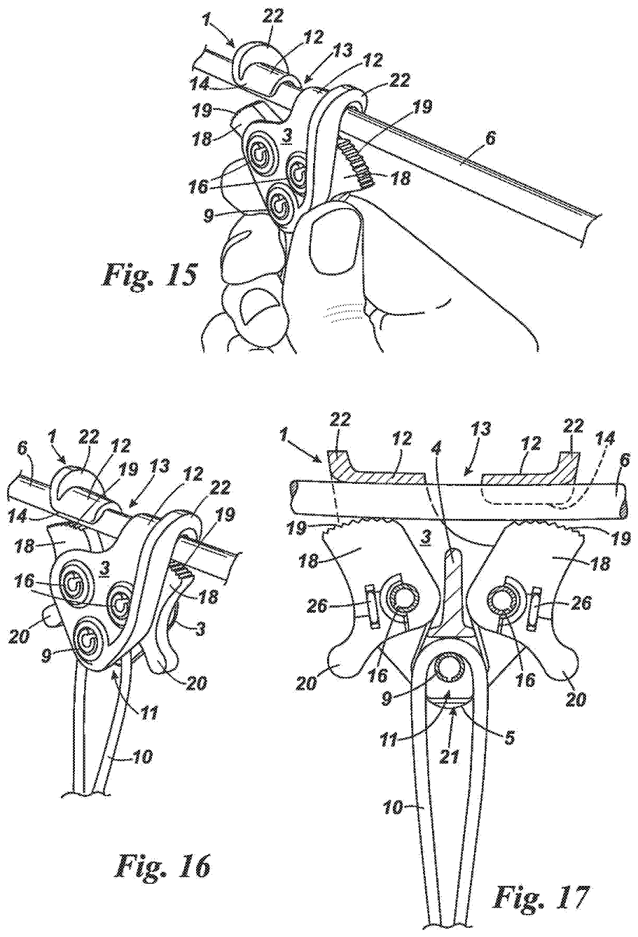

The gripping device 1 is fastened to the elongate support 6 by carrying out the following steps: presenting the gap 13 to the elongate support 6, as shown in FIG. 12; grasping the lower arms 20 between finger and thumb of one hand, as shown in FIG. 13, to rock the cam levers 15 and move the cam faces 19 away from the hooks 12 against the urge of the spring means 21; rotating the device, as indicated by the curved arrow in FIG. 14, about an axis (not shown) through the middle of the gap and the centre of the lower end 5 of the device, for the elongate support 6 to each side of the gap to pass between the free end 14 of the respective hook 12 and cam face 19, to bring the device to the position shown in FIG. 15; then releasing the grip on the lower arms 20 to allow the spring means 21 to urge them apart and rock the cam levers 15 to cause the cam faces 19 to urge the elongate support 6 against their respective hooks 12.

Adjustment of the position of the gripping device 1 along the elongate support 6 can be effected by again grasping the lower arms 20 to release the cam faces 19, sliding the device along the elongate support 6 to its required position, and then releasing the grip on the lower arms to again allow the cam faces 19 to urge the elongate support 6 against the hooks 12.

FIG. 18 shows the gripping device 1 for use in a suspension assembly 100. An upper region of the suspension assembly 100 is shown in FIGS. 18 and 19. The lower region of the suspension assembly 100 is not shown, but it will be appreciated by those skilled in the art that it is the same as the upper region shown in the drawings, with the gripping device 1 at the lower end secured to the conductive elongate contact cable. In the embodiment shown in FIGS. 18 to 24, the elongate contact cable is arranged to be engaged by the pantograph of a train travelling underneath.

The gripping device 1 is shown in FIG. 18 fastened to the elongate support 6 in the manner described above. The feature of the opposite curving hooks 12 of the gripping device 1 allows the gripping device 1 to be fastened to an elongate support 6 already installed, without any need for disassembly of the overhead electric cable apparatus.

FIG. 19 shows the gripping device 1 secured to the elongate support 6, with an elongate member 10, in the form of a dropper cable, suspended therefrom. The elongate member 10 is conductive to allow electricity to be passed from the elongate support 6 to the elongate contact cable. The elongate member 10 comprises a conductive wire rope.

As shown in FIG. 19, the elongate member 10 is suspended from the gripping device 1 by the pin 9. The elongate member 10 is clamped in a suspended position shown in FIG. 19 by means of the clamping device 30 through which two passes 10A, 10B of the elongate member 10 extend. An example of a suitable clamping device 30 is disclosed in GB2415012A.

Referring to FIG. 20, the clamping device 30 has a housing 111 defining two through passages 112A, 112B separated by a clamping wall 114. Each of the passes 10A, 10B is received in a respective one of the passages 112A, 112B.

A respective clamping mechanism 115A, 115B is provided for each passage 112A, 112B. Each clamping mechanism 115A, 115B has a securing member comprising a clamping member 117A, 117B to clamp the pass 10A or 10B against the clamping wall 114. Each of the clamping members 117A, 117B is in the form of a wedge.

Each clamping mechanism 115A, 115B extends along a respective reaction wall 116A, 116B arranged on opposite sides of the clamping wall. Each of the reaction walls 116A, 116B converges towards the clamping wall 114. Each clamping mechanism 115A, further includes a spring 122A, 122B to urge the clamping member along the channel towards the passage. Each of the springs 122A, 122B is in the form of a coil compression spring.

Each clamping mechanism 115A, 115B further includes an abutment 118A, 118B arranged at opposite ends of the housing 111, against which the springs 122A, 122B to provide a reaction force for the springs 122A, 122B to enable the springs 122A, 122B to urge the clamping members 117A, 117B into engagement with the passes 10A, 10B of the elongate member 10.

Each clamping mechanism 115A, 115B further includes a locking arrangement to lock the clamping members 117A, 117B in clamping engagement with the passes 10A, 10B of the elongate member 10.

The locking arrangement comprises a respective hole 119A, 119B defined by the abutments 118A, 118B. The locking arrangement also includes a respective screw 120A, 120B extending through each hole 119A, 119B and through the coils of the springs 122A, 122B.

Each of the screws 120A, 120B has a proximal end comprising a head 121A, 121B, and a distal end 128A, 128B inside the housing. The distal end 128A, 128B of each screw 120A, 120B can engage the respective clamping member 117A, 117B to lock the clamping member 117A, 117B in clamping engagement with the respective pass 10A, 10B.

In the embodiment shown, the proximal ends 121A, 121B are provided with hexagon heads for effecting rotation of the screw 120A, 120B. Alternatively, the head 121A, 121B could define a slotted recess or a cruciform recess to receive a suitable screwdriver, or a hexagonal recess to receive a suitable hex key.

When the passes 10A, 10B of the elongate member 10 are received in the passages 112A, 112B, each clamping member 117A, 117B is urged by the respective springs 122A, 122B into engagement with the passes 10A, 10B of the elongate member 10.

The passes 10A, 10B can then be pulled in a direction which pulls the clamping members 117A, 11B into the narrowing spaces between the clamping wall 114 and the reaction walls 116A, 116B. This has the effect of the clamping members 117A, 117B and the passes 10A, 10B of the elongate member 10 being clamped tightly between the reaction walls 116A, 116B and the clamping wall 114.

When so clamped, the clamping members 117A, 117B can be locked in position by screwing the screws 120A, 120B into the holes 119A, 119B until they engage the clamping members 117A, 117B.

In use, the elongate member 10 is inserted into the respective passages 112A, 112B in the directions indicated by the arrows A and B in FIGS. 19, 20, 21 and 24, and then pulled in the opposite directions to cause the clamping members 117A, 117B to move into tight clamping engagement with the passes 10A, 10B of the elongate member 10.

Thus, each passage 112A, 112B is configured to receive a respective one of the passes 10A, 10B of the elongate member 10. When so received, the clamping mechanisms are operable on the passes 10A, 10B of the elongate member 10.

In order to provide an electrical connection between the elongate member 10 and the elongate support 6, the elongate member 10 is adjusted relative to the clamping device 30 so that the end region 10C is long enough to extend from the clamping device 30 to the gripping device 1. As shown, the end region 10C extends through the hooks 12 in contact with the elongate support 6.

The end region 10C of the elongate member 10 and the elongate support 6 are clamped against one another and the hooks 12 by the cam faces 19 of the upper arms 18. This creates an electrical connection between the elongate support 6 and the elongate member 10.

The elongate member 10 has a main portion 10D which extends downwardly to a further clamping device 30 and a further gripping device 1. The further clamping and gripping devices 30, 1 fasten the elongate member 10 to the elongate contact cable, and are the same as the gripping device 1 and the clamping device 30.

In FIG. 21, the clamping device 30 is connected to the gripping device 1 by a connecting portion 32. The elongate member 10 is clamped in one of the passages 112A, 112B and extends therefrom across the elongate support 6 at a contact region 10E where the elongate support 6 extends through the gap 13. The elongate member 10 extends from the elongate support 6 back to the clamping device 30 and is received in the other of the passages 112A, 112B to be clamped therein.

By clamping the elongate member 10 in both passages 112A, 112B, the connecting portion 32 allows the clamping device 30 to hold the elongate member 10 tightly against the elongate support 6 at the region 10E of the elongate member 10. As a result, an electrical connection is created between the elongate support 6 and the elongate member 10.

FIGS. 22 and 23 show another embodiment, comprising a further gripping device 34, generally designated. The gripping device 34 comprises a main part 36 in the form of a body. The main part 36 has the hooks 12 thereon. The hooks 12 of the gripping device 34 are the same as the hooks 12 of the gripping device 1, and curve over in opposite directions to engage the elongate support 6.

Instead of two cam levers 15, the further gripping device 34 includes a single securing member in the form of a cam member 38. The cam member 38 is pivotally attached to the main part 36. The cam member 38 is partially circular having a substantially planar engaging region 40 for engaging the elongate support 6. When the elongate support 6 is so engaged, the cam member 38 fastens the elongate support 6 to the gripping device 34.

An urging member, in the form of an over-centre lever 42, is connected to the cam member 38. The cam member 38 is pivotally attached to the main part 36 of the gripping device 34 at a pivot point 44 offset from the centre of the cam member 38 in a direction away from the engaging region 40. Thus, the distance from the pivot point 44 to the engaging region 40 of the cam member 38 is greater than the distance from the pivot point 44 to the region of the cam member 38 opposite the engaging region 40.

The cam member 38 is pivotable through 180° between a gripping position shown in FIG. 22, and a non-gripping position shown in FIG. 23. The pivoting of the cam member 38 is effected by moving the over-centre lever 42 through 180°. In the gripping position, the engaging region 40 engages the elongate support 6 to press the elongate support 6 against the hooks 12, thereby fastening the gripping device 34 to the elongate support 6.

In the non-gripping position, the engaging region 40 is disengaged from the elongate support 6 to allow the gripping device 34 to be moved along the elongate support 6, or removed therefrom.

FIG. 24 shows the gripping device 34 secured to the elongate support 6, with the elongate member 10 suspended therefrom.

The elongate member 10 extends through the main part 36 at a lower end thereof and is suspended from the gripping device 34. The elongate member 10 is secured in its suspended position by means of the clamping device 30 in the same way as described above with reference to FIG. 19.

The end region 10C extends from the clamping device 30 to the gripping device 34, extending through the hooks 12 in contact with the elongate support 6.

The end region 10C of the elongate member 10 and the elongate support 6 are clamped against one another and against the hooks 12 by the cam member 38 when the cam member 38 is in the gripping position. This creates the electrical connection between the elongate support 6 and the elongate member 10.

The clamping device 30 is shown in FIG. 24 separate from the gripping device 34, similar to FIG. 21, which shows the gripping device 1 separate from the clamping device 30. If desired, the gripping device 34 could be connected to the clamping device 30 by a connecting portion 32, similar to the connecting portion 32 shown in FIG. 21. With such a connecting portion 32 to connect the gripping device 34 to the clamping device 30, the elongate member 10 may be arranged in contact with the elongate member 10 in the same way as shown in FIG. 21.

FIG. 25 shows a further suspension assembly 100 in which a clamping device generally designated 44 is provided. The clamping device 44 is shown in more detail in FIG. 26, and comprises a single passage 54 through a body 45. The elongate member 10 extends through the passage 54. The clamping device 44 also has a clamping mechanism 56 to clamp the elongate member 10 in the passage 54. The clamping mechanism 56 has two oppositely arranged securing members, which comprise clamping members 60. The clamping members are in the form of wedges.

The clamping members 60 are mounted on a carriage 62. A spring arrangement 64 urges the carriage 62 in the direction indicated by the arrow D to a clamping position. An example of a suitable such clamping device 44 is disclosed in GB2560418.

The gripping device 34 is connected to the clamping device 44 by a connecting portion 46. The elongate member 10 is inserted through the clamping device 44 in the direction indicated by the arrow C. The end region 10C of the elongate member 10 can then be arranged to extend from the clamping device 44 to the gripping device 34, through the hooks 12 in contact with the elongate support 6.

The end region 10C of the elongate member 10 and the elongate support 6 are then clamped against one another and against the hooks 12 by the cam member 38 when the cam member 38 is in the gripping position. This creates the electrical connection between the elongate support 6 and the elongate member 10.

FIG. 25 shows the clamping device 44 connected to the gripping device 34. Alternatively, the suspension assembly 100 could comprise the gripping device 1 connected to the clamping device 44 by the connecting portion 32.

The clamping device 44 has a locking arrangement in the form of a threaded member 48 on the carriage 62. The threaded member 48 projects from the body 45. A locking member 50 can be screwed onto the threaded member 48 to lock the clamping members 60 in the clamping position in clamping engagement with the elongate member 10.

In other embodiments, the end region 10C could be attached to the housing of the gripping device 1 or the gripping device 34 and held against the elongate support 6 by gravity. Alternatively, the end region 10C of the elongate member 10 could be electrically attached to the housing, whereby the electrical conductivity of the components from which the gripping device 1 or gripping device 34 are made provides the electrical connection between the elongate support 6 and the elongate member 10.

There is thus described a suspension assembly 100 that is easily adjustable along the elongate support 6. The suspension assembly 100 can be retrofitted to existing overhead electric lines, and can be used in lines being constructed. In addition to being adjustable along the elongate support 6 by means of the gripping device 1 and the gripping device 34, the elongate member 10 can be adjusted relative to the clamping device 30 or the clamping device 44.

The embodiments of the suspension assembly 100 described above provide the further advantage that the time to install or repair overhead electrical lines is significantly reduced.

The provision of the hooks 12 means that the suspension assembly 100 provides a fail-safe system in that, once the hooks 12 are installed on the elongate support 6, the suspension assembly 100 cannot be dropped even if the user lets go of it.

A minimal number of tools are needed to install the suspension assembly 100. Therefore, there is a reduced risk of the user forgetting to bring the correct tools, or selecting the wrong tools.

Much of the working to install suspension assembly 100s is carried out at height. The present invention reduces the amount of time spent at height, which provides a health and safety benefit.

The cam and the cam levers 15 provide a firm grip on the elongate support 6 and on the contact cable, thereby reducing the risk of the suspension assembly 100 moving along either the contact cable or the elongate support 6, or both.

It is important that the suspension assembly 100 can carry current uninterrupted. The embodiments described above ensure that the elongate member 10 is in contact with the elongate support 6 and the contact cable or attached the securely to the housing.

The length of the dropper is predetermined to maintain the correct distance between the elongate support 6 and the contact cable. When this is not adjustable placement and planning of drop lengths becomes difficult and time consuming. The provision of the suspension assembly 100 described above provides the desired adjustability.

In addition, the ability to lock the clamping mechanism 115A, 115B, 56 means that upwards forces from the trains on the elongate member 10 do not act to tighten the cable and change the length thereof.

Various modifications can be made without departing from the scope of the invention. For example, the over-centre lever 42 and the cam member 38 may be pivotable by an angle of greater or less than 180º.

In another modification, the locking arrangement comprises a cam locking arrangement, such as disclosed in GB2492621 and shown in FIGS. 27 to 29.

The cam locking arrangement is provided in a clamping device 70 that is similar to the clamping device 30 described above and shown in FIG. 20. The clamping device 70 possesses many of the features of the clamping device 30, and these are designated with the same reference numerals as the corresponding features shown in FIG. 20.

The clamping device 70 differs from the clamping device 30 in that the clamping wall 114 is wider, holding within it a cam locking member 72. The cam locking member 72 comprises a main cam portion 74 and an operating portion 76 on the main cam portion.

The main cam portion 74 of the cam locking member 72 is held within an aperture 78 in the clamping wall 114. The operating portion 76 is arranged outside the housing 111, so that it can be rotated by a user with, for example, a hex key or a spanner.

The main cam portion 74 comprises two opposite substantially flat faces 80 and two opposite cam surfaces 82, which are arranged alternately on the main cam portion 74. The cam surfaces 82 are convexly curved surfaces.

The cam locking member 72 is rotatable between a non-locking position shown in FIG. 27, and a locking position shown in FIG. 28. In the non-locking position, the substantially flat faces 80 are aligned with the respective surfaces of the clamping wall 114. In the locking position, the cam surfaces 82 protrude into the passages 112A, 112B.

In use, the two passes 10A, 10B are initially clamped by the clamping members 117A, 117B, with the cam locking member 72 in the non-locking position. The cam locking member 72 is then rotated to the locking position. In the locking position, the cam surfaces 82 push the passes 10A, 10B against the respective clamping member 117A, 117B to lock the passes 10A, 10B in the passages 112A, 112B.

FIGS. 30 to 33 illustrate a further securing arrangement 102 comprising an integrated gripping device 1 and clamping device 44. In the preceding Figures, the gripping device and clamping device are separate non-connected parts or are connected in series by a connecting portion 46. By contrast, the illustrated integrated gripping device 1 and clamping device 44 are in a layered arrangement. They may share common parts with each other in order for each to function.

The advantage is a single unit that grips the elongate support 6 by adjustable means and clamps the elongate member 10 by adjustable means.

The gripping device 1 may be functionally similar to that shown in FIGS. 1 to 21. The clamping device 44 may be functionally similar to that shown in FIGS. 25 and 26.

The clamping device 44 replaces the medial wall 4 of FIGS. 6-8. The main part 2 has two spaced plate-like side members 3 connected together by the clamping device 44 layered between the side members 3.

The body 45 of the clamping device 44 is a carrier for the side members 3 of the gripping device 1, in addition to being a housing defining a passage 54 and containing a clamping mechanism 56. The body 45 of the clamping device 44 is a chassis against which the side members 3 may be secured.

The side members 3 include a first side member 3A secured to a first side of the clamping device 44 and a second side member 3B secured to a second opposite side of the clamping device 44.

Pins 16 may secure the side members 3 and the body 45 of the clamping device 44 together. The pins 16 may be bolts. The pins 16 may be threaded. The pins 16 may comprise tool heads such as hex sockets or slots.

A first type of connection comprises a pin 16 extending through a hole in a side member 3B, through an aligned hole the body 45 of the clamping device 44, and into threaded engagement with a threaded hole in the opposite side member 3A. The pin 16 can be tightened to compress both side members 3 against the body 45 of the clamping device 44.

A second type of connection comprises a pin 16 extending through a hole in the second side member 3B and into threaded engagement with a threaded hole in the body 45 of the clamping device 44. The pin 16 can be tightened to compress the second side member 3B against the body 45 of the clamping device 44.

Regarding the number of pins 16, each side member 3 may have at least three points of engagement through the body 45 of the clamping device 44. At least three points of engagement ensures that the side members 3 are properly immobilised.

A first subset of the at least three pins 16 may utilise the first type of connection. A second subset of the at least three pins 16 may utilise the second type of connection.

As shown in FIG. 30, the second side member 3B may be secured against the clamping device 44 by four pins 16. The four pins 16 may be located at four corners of the second side member 3B. The upper two pins 16 may utilise the first type of connection, to connect the side members 3A, 3B to each other. The lower two pins 16 may utilise the second type of connection, to connect the second side member 3B to the body 45. The first side member 3A therefore requires a third point of engagement since there are only two pins through the first side member 3A. As shown in FIG. 33, a plug-socket arrangement 90 can provide the third point of engagement. The body 45 of the clamping device 44 may comprise the plug and the first side member 3A may comprise the socket, or vice versa.

In an example efficient method of manufacture, the individual components 3A, 45, 56, 3B of the gripping device 1 and clamping device 44 may be laid on a jig in a layered arrangement, and then the pins 16 may be fed through the side members 3 and the clamping device 44 and tightened.

FIG. 31 illustrates the clamping device 44 prior to attachment of the second side member 3B, such that internal components of the clamping device 44 are visible. FIG. 32 illustrates the clamping device 44 in side cross-section, such that the internal components of the clamping device 44 are visible from the side. The internal components of the clamping device 44 are now described.

The clamping mechanism 56 in FIGS. 31 and 32 may be different from the clamping mechanism 56 shown in FIG. 26. For example, the clamping mechanism 56 of FIGS. 31 and 32 comprises one clamping member 60 rather than two clamping members 60. This does not reduce the clamping force.

Further, the clamping mechanism 56 may clamp the elongate member 10 against an electrical conductor. The clamping member 60 wedges the main portion 10D of the elongate member 10 in the passage 54 between the reaction wall 116A of the body 45 of the clamping device 44 and an electrically conductive clamping wall 114 of the second side member 3B of the gripping device 1. This arrangement differs from the previous examples because one wall 114 is part of a side member 3B of the gripping device 1 rather than both walls 114, 116A being parts of the body 45 of the clamping device 44.

The clamping member 60 therefore urges the main portion 10D of the elongate member 10 against an interior surface (clamping wall 114) of the second side member 3B. The second side member 3B may be an electrical conductor, comprising electrically conductive material such as copper.

Electrical current is transferred from the elongate support 6 to the second side member 3B via the hook 12 of the second side member 3B, and is then transferred from the second side member 3B to the elongate member 10 because the elongate member 10 is clamped against the second side member 3B.

This means that it is no longer necessary for the end of the elongate member 10 to be in direct contact with the elongate support 6 as shown in FIGS. 24 to 25, to transfer electrical power. In addition, the clamping force helps to maintain a strong and reliable electrical interface. It would be appreciated that the approach from FIGS. 24 and 25 could continue to be used as a second electrical connection.

As shown in FIG. 30, the second side member 3B may comprise an elongate wall 3C extending down from the hook 12 of the second side member 3B. The elongate wall 3C may be parallel to the passage 54. The side of the elongate wall 3C facing the passage 54 comprises the clamping wall 114.

The illustrated first side member 3A does not have a corresponding elongate wall 3C because there is no clamping mechanism 56 at the side of the clamping device 44 to which the first side member 3A is secured. However, in another embodiment, the first side member 3A could comprise an elongate wall 3A, to provide a second clamping wall 114 for a second clamping mechanism 56 of the clamping device 44.

Another optional difference of the clamping mechanism 56 shown in FIGS. 31 and 32 is the locking arrangement. The external locking member 50 at the lower end of the carriage 62 may be replaced by a push button 92. The push button 92 can be pushed up towards the body 45 of the clamping device 44 to the carriage 62 upwardly. This slides the clamping member 60 away from the passage 54 to release the clamping force.

Another optional difference of the clamping mechanism 56 shown in FIGS. 31 and 32 is that instead of securing the push button 92 to a threaded member 48, the push button 92 may be snap fit onto the lower end of the carriage 62.

Another optional difference of the clamping mechanism 56 shown in FIGS. 31 and 32 is that the spring arrangement 64 can be external to the body 45 rather than internal. The spring arrangement 45 may be seated on the push button 92. The spring arrangement 64 may be compressed between the push button 92 and the body 45 of the clamping device 44. The spring arrangement 64 urges the carriage 62, to which the push button 92 is connected, to the clamping position.

The spring arrangement 64 may comprise a coil spring. The spring arrangement 64 may have an hourglass shape (concave shape) to damp the vibration which can occur as a result of passing trains.

The carriage 62 may extend through the centre axis of the spring arrangement 64 and into the body 45. The passage 54 may extend through the push button 92, through the carriage 62, and through the body 45.

A method for damping vibrations comprises making the inner diameter of the passage 54 an interference fit with the main portion 10D of the elongate member 10, upstream of the clamping member 60. The carriage 62 may comprise this interference fit inner diameter. This ensures that vibrations in the elongate member 10 are damped inside the carriage 62 and are not passed to the clamping member 60.

Another optional difference of the further securing arrangement 102 of FIGS. 30 to 33 is the manner in which the end region 10C of the elongate member 10 may be connected to the securing arrangement 102. The end region 10C may be connectable in a manner that provides a more secure backup connection of the elongate member 10 should the clamping mechanism 56 fail.

As shown in FIGS. 30 to 33, the securing arrangement 102 can comprise one or more holes 7 for the end region 10C of the elongate member 10. The one or more holes 7 may be proximal to the lower end 5. The Figures show a specific implementation wherein the body 45 of the clamping device 44 comprises the one or more holes 7.

The direction of the one or more holes 7 may be nonparallel to the passage 54. The one or more holes 7 may be approximately perpendicular to the passage 56. The end region 10C of the elongate member 10 may be looped from the exit of the passage 56 through the one or more holes 7.

FIGS. 30 to 33 illustrate a plurality of holes 7 for the end region 10C of the elongate member 10 (e.g., two holes 7). Therefore, the end region 10C of the elongate member 10 can be looped through the securing arrangement 102 a plurality of times. If the clamping mechanism 56 fails, the elongate member 10 will hang from the loop or loops.

A further optional difference of the gripping device 1 is that the spring means 21 for the cam levers 15 may be different from the shared spring means 21 shown in FIGS. 9 to 10. FIGS. 30 and 31 illustrate the spring means 21 comprising an individual, separate torsion spring for each cam lever 15. The spring means 21 for each cam lever 15 may be wound around a pin 16 of the cam lever 15. The use of separate spring means 21 prevents interference with the body 45 of the clamping device 44.

Although FIGS. 30 to 33 specifically illustrate the integration of gripping device 1 with clamping device 44, it would be appreciated that many of the above-described features of FIGS. 30 to 33 would also be applicable if the clamping device 44 is swapped for the clamping device 30, and/or if the gripping device 1 is swapped for the gripping device 34.

1. A securing arrangement for a dropper assembly to suspend a dropper cable, wherein the securing arrangement comprises a first securing device to secure a messenger wire, and the securing arrangement further includes a second securing device to secure the dropper cable, wherein each of the first and second securing devices comprises a main part, a securing member movably mounted on the main part, and a urging member in the form of a spring to urge the respective securing member from a release position to a securing position in which the respective one of the messenger wire or the dropper cable is secured by the respective securing member.

2. (canceled)

3. The securing arrangement of claim 1, wherein the first securing device comprises a gripping device arranged to grip the messenger wire.

4. The securing arrangement of claim 3, wherein the gripping device has hooks extending from the main part, wherein the hooks curve in opposite directions from the main part, wherein a gap is defined between the hooks, wherein the messenger wire is receivable in the gap, and when the gripping device is rotated about the gap the messenger wire is received by both hooks.

5. The securing arrangement of claim 3, wherein the securing member of the gripping device comprises a cam lever pivotally mounted on the main part of the gripping device.

6. The securing arrangement of claim 5, wherein the cam lever comprises a cam face to engage the messenger wire, and a release member to release the cam face from the messenger wire.

7. (canceled)

8. The securing arrangement of claim 3, wherein the gripping device comprises two of the securing members and two of the springs.

9. The securing arrangement of claim 8, wherein each securing member of the gripping device is to press the messenger wire against a different hook of the gripping device.

10. The securing arrangement of claim 1, wherein the second securing device comprises a clamping device, wherein the clamping device comprises a passage through which the dropper cable extends.

11. The securing arrangement of claim 10, wherein the clamping device has a clamping mechanism to clamp the dropper cable in the passage, wherein the securing member of the second securing device is a clamping member of the clamping mechanism.

12. The securing arrangement of claim 11, wherein the clamping mechanism includes the spring of the second securing device, to urge the clamping member to a clamping position in which the dropper cable is clamped.

13. The securing arrangement of claim 12, wherein the urging of the clamping member to the clamping position urges the clamping member towards the passage.

14. (canceled)

15. The securing arrangement of claim 12, wherein the clamping device has a locking arrangement to lock the clamping member in the clamping position, wherein the locking arrangement comprises a button which is actuatable by hand to release the clamping member, wherein when the button is released, the spring of the clamping mechanism returns the clamping member to the clamping position.

16. The securing arrangement of claim 11, wherein the clamping mechanism is to clamp the dropper cable against an electrical conductor to enable electrical power transfer between the messenger wire and the dropper cable.

17. The securing arrangement of claim 11, wherein the first securing device and the second securing device are in a layered arrangement.

18. The securing arrangement of claim 17, wherein the main part of the first securing device has two side members connected together by the clamping device, wherein the clamping device is layered between the side members.

19. (canceled)

20. The securing arrangement of claim 18, wherein the clamping member is arranged to urge a main portion of the dropper cable against an interior surface of one of the side members, wherein the one of the side members is an electrical conductor.

21. (canceled)

22. The securing arrangement of claim 10, wherein the securing arrangement comprises one or more holes through which an end region of the dropper cable can be looped, wherein the direction of the one or more holes is nonparallel to the passage.

23. AA dropper assembly for use with overhead electric lines for electric railway systems, the dropper assembly comprising:
a securing arrangement as claimed in claim 1; and
a dropper cable suspended from the securing arrangement.

24. The dropper assembly of claim 23, wherein the dropper cable has a main portion which extends downwardly to a further securing arrangement for securing the dropper cable to an elongate contact cable.

25. A method of using a dropper assembly as claimed in claim 23 to suspend an dropper cable, the method comprising fastening the first securing device to the messenger wire, and fastening the dropper cable to the second securing device.
